(19) United States
(12) Patent Application Publication
(10) Pub. No.: US 2023/0085988 A1
(43) Pub. Date: Mar. 23, 2023

(54) SYSTEM AND METHOD OF CAPTURING AND TRANSMITTING DATA FROM A WEARABLE ELECTRONIC DEVICE

(71) Applicant: Sam Salemnia, Los Angeles, CA (US)

(72) Inventor: Sam Salemnia, Los Angeles, CA (US)

(21) Appl. No.: 17/934,151

(22) Filed: Sep. 21, 2022

Related U.S. Application Data
(60) Provisional application No. 63/246,672, filed on Sep. 21, 2021.

(51) Int. Cl. H04N 7/18; H04N 5/265; H04N 5/232

(52) U.S. Cl. CPC H04N 7/185; H04N 5/265; H04N 5/23216; H04N 5/23238

(57) ABSTRACT

A method of transmitting integrated media to a display device includes integrating data captured by a wearable camera device with video captured by a camera system to form the integrated media, and transmitting the integrated media to a display device remote from the wearable camera device and the camera system.

### CROSS-REFERENCE TO RELATED APPLICATION(S)

The present application claims priority to and the benefit of U.S. Provisional Patent Application No. 63/246,672, filed Sep. 21, 2021, the entire contents of which are incorporated herein by reference.

### BACKGROUND

### 1. Field

The present disclosure relates to various system and methods of capturing and transmitting data captured from a wearable electronic device.

### 2. Description of the Related Art

Videos of a scene are typically captured from a third-person perspective. For instance, video of a sporting event or competition, such as a football game or a soccer match, are typically captured by a sideline camera or an overhead camera. However, these cameras alone are unable to capture all of the action of the sporting event. For instance, the ball and/or certain players may be obstructed by other players. Moreover, these third-person perspective cameras cannot adequately replicate the perspective of the athlete during the performing of a sporting event or other athletic competition.

### SUMMARY

The present disclosure relates to various embodiments of a method of transmitting integrated media to a display device. In one embodiment, the method includes integrating data captured by a wearable camera device with video captured by a camera system to form the integrated media, and transmitting the integrated media to a display device remote from the wearable camera device and the camera system.

The data captured by the wearable camera device may include a first-person video from an individual in a scene, and the video captured by the camera system may include third-person video of the individual in the scene.

The first-person video and the third-person video may be played simultaneously or sequentially in the integrated media.

The integrated media may include a 360-degree video.

The wearable camera device may be worn by an athlete during performance of an athletic event.

The data may be a video, biometric data, location data, or combinations thereof.

The wearable electronic device may be a helmet, a baseball cap, or a sweatband.

The data may include positional data of an athlete on a sporting field wearing the wearable camera device, the integrated media may include an avatar of the athlete on a graphic representation of the sporting field, and a position of the avatar may correspond to the positional data.

The present disclosure also relates to various methods of displaying integrated media on a display device. In one embodiment, the method includes receiving, by the display device, integrated media including data captured by at least one wearable camera device and video captured by a camera system, and displaying, on a display of the display device, the integrated media.

The data captured by the at least one wearable camera device includes a first video feed captured by a first wearable camera device and a second video feed captured by a second wearable camera device.

The method may also include displaying, on the display of the display device, a menu, and displaying, on the display of the display device, the first video feed or the second video feed in response to a selection entered in the menu.

The data captured by the wearable camera device may include a first-person video from an individual in a scene, and the video captured by the camera system may include third-person video of the individual in the scene.

Displaying the integrated media may include simultaneously or sequentially playing the first-person video and the third-person video on the display of the display device.

The wearable camera device may be worn by an athlete during performance of an athletic event.

The data may be a video, biometric data, location data, or combinations thereof.

The wearable electronic device may be a helmet, a baseball cap, or a sweatband.

The data may include positional data of an athlete on a sporting field wearing the wearable camera device, the integrated media may include an avatar of the athlete on a graphic representation of the sporting field, and a position of the avatar may correspond to the positional data.

The integrated media may include a 360-degree video.

The present disclosure also relates to various embodiments of a non-volatile memory device. In one embodiment, the non-volatile memory device has instructions stored therein which, when executed by a processor, cause the processor to integrate data captured by a wearable camera device with video captured by a camera system to form integrated media, and to transmit the integrated media to an electronic device remote from the wearable camera device and the camera system.

The data captured by the wearable camera device may include a first-person video from an individual in a scene, and the video captured by the camera system may include a third-person video of the individual in the scene.

The first-person video and the third-person video may be played simultaneously or sequentially in the integrated media.

The wearable camera device may be worn by an athlete during performance of an athletic event.

The data may be a video, biometric data, location data, or combinations thereof.

The wearable electronic device may be a helmet, a baseball cap, or a sweatband.

The data may include positional data of an athlete on a sporting field wearing the wearable camera device, the integrated media may include an avatar of the athlete on a graphic representation of the sporting field, and a position of the avatar may correspond to the positional data.

The integrated media may include a 360-degree video.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features may be combined with one or more other described features to provide a workable method or device.

### BRIEF DESCRIPTION OF THE DRAWINGS

The accompanying drawings, together with the specification, illustrate exemplary embodiments of the present disclosure, and, together with the description, serve to explain the principles of the present disclosure. The drawings are not necessarily drawn to scale.

FIG. 1 is a schematic view of a system for integrating data captured from a wearable device with data captured from a remote camera system;

FIG. 2 is a schematic view of a display of an electronic device displaying a video feed from the remote camera system and data from the wearable device; and

FIG. 3 is a flowchart illustrating tasks of a method of integrating data captured from a wearable device with data from a remote camera system.

### DETAILED DESCRIPTION

The present disclosure relates to various embodiments of a system and method of capturing video data, biometric data, and/or locational data from a wearable electronic device. The wearable electronic device may be worn, for example, by an athlete during performance in an athletic event. In one or more embodiments, the data captured from the video system worn by the individual is integrated with video data of the individual captured by another video system remote from the individual.

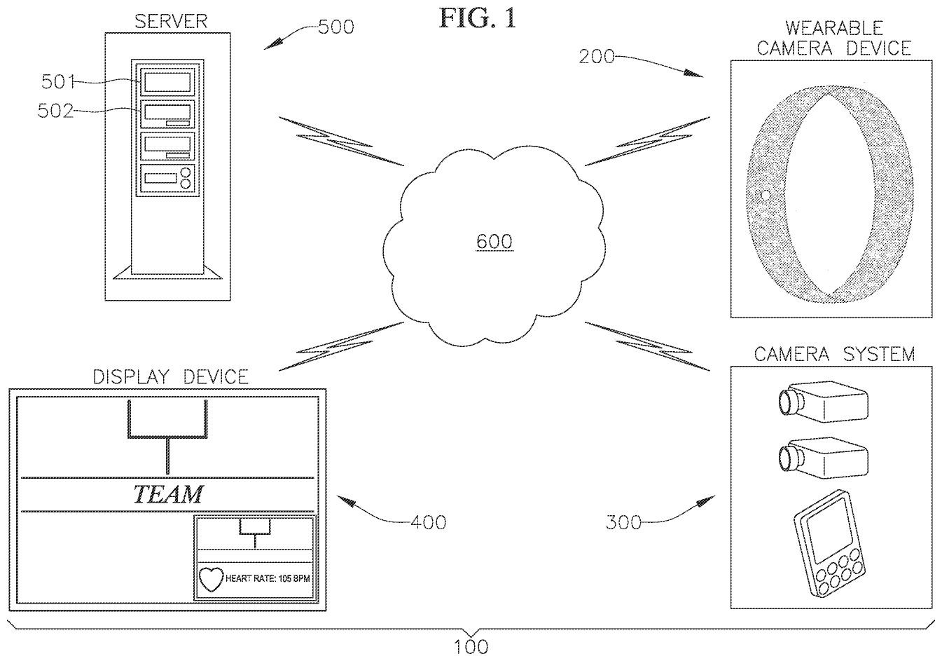

FIG. 1 is a block diagram of a system 100 according to one embodiment of the present disclosure. In the illustrated embodiment, the system 100 includes at least one wearable camera device 200, a camera system 300 remote from the wearable electronic device 200, a display device 400 (e.g., a television or a computer, such as a laptop, a desktop computer, a tablet computer, or a wearable electronic device, such as a smartwatch, smart glasses, or augmented reality (AR) or virtual reality (VR) headset), and at least one server 500. The wearable camera device 200, the camera system 300, the display device 400, and the server 500 are configured to communicate with each other over a data network 600 (e.g., a wired or wireless data network). In one or more embodiments, the wearable camera device 200 may be the same as or similar to one of the body mounted camera systems disclosed in U.S. patent application Ser. No. 15/342,068 filed on Nov. 2, 2016 (issued as U.S. Pat. No. 10,630,871 on Apr. 21, 2020), U.S. patent application Ser. No. 16/785,154 filed on Feb. 7, 2020 (issued as U.S. Pat. No. 10,798,274 on Oct. 6, 2020), and U.S. patent application Ser. No. 17/063,561 filed on Oct. 5, 2020, or one of the head mountable camera systems disclosed in U.S. patent application Ser. No. 16/898,010 filed on Jun. 10, 2020, the entire contents of each of which are incorporated herein by reference.

The camera system 300 is configured to capture video (e.g., real-time video) of a scene or an event, such as a match, a game, a sporting event, a competition, or other athletic activity. In one or more embodiments, the camera system 300 may be a standard sideline video camera, a handheld video camera, or an aerial video camera (e.g., a computer-controlled, cable-suspended video system). In one or more embodiments, the camera system 300 is configured to capture video of the user wearing the wearable camera device 200 in the scene or during the event. Additionally, in one or more embodiments, the camera system 300 is configured to transmit (wired or wirelessly) the video captured by the camera system 300 to the server 500.

The wearable camera device 200 is configured to be worn by an individual, such as an athlete during performance at a match, a game, a sporting event, a competition, or other athletic activity. In one or more embodiments, the wearable camera device 200 may be, for example, incorporated into a helmet (e.g., a football helmet), a baseball cap, or a headband worn by the athlete. The wearable camera device 200 is configured to capture a variety of data during the athlete's performance of the athletic event, such as real-time video of the athletic event from the athlete's perspective, biometric data of the athlete (e.g., the athlete's heart rate), positional data of the athlete (e.g., location of the athlete on the field, such as a football field, a soccer field, a baseball diamond, or other playing surface and/or the location of the athlete relative to other athletes), and/or dynamic data of the athlete (e.g., the speed and/or acceleration of the athlete). In one or more embodiments, the data captured by the wearable camera device 200 includes 360-degree video. Additionally, in one or more embodiments, the wearable camera device 200 is configured to wirelessly transmit the data (e.g., video, biometric data, positional data, and/or dynamic data) captured by the wearable camera device 200 to the server 500.

In one or more embodiments, the server 500 includes instructions that, when executed by a processor 501 of the server 500, cause the processor 501 to integrate the data captured by wearable camera device 200 with the video captured by the camera system 300, and to transmit a signal having computer executable instructions including the integrated data and video to the display device 400. The instructions may be stored in a memory device 502 of the server 500.

In one or more embodiments, the executable instructions of the signal, when executed by a processor of the display device 400, cause the display device 400 to display, on a display of the display device 400, the data captured by the wearable camera device 200 integrated with the video captured by the camera system 300. For instance, in one or more embodiments, the signal, when executed by a processor of the display device 400, causes the display device 400 to display, on a display of the display device 400, the video captured by the wearable camera device 200 worn by the user overlaid or positioned in close proximity to (e.g., adjacent to) the video captured by the camera system 300. In this manner, a viewer may be able to view both a third-person and first-person perspective of the individual wearing the wearable camera device 200.

In one or more embodiments, the signal, when executed by the processor of the display device 400, causes the display device 400 to display the biometric data and/or locational (e.g., geographic) data of the user captured by the wearable camera device 200 overlaid on the video of user captured by the camera system 300 and/or the video captured by the wearable camera device 200. For instance, in one or more embodiments in which the wearable camera device 200 is worn by an athlete (e.g., incorporated into the athlete's helmet or sweatband) and the camera system 300 is configured to capture video of a sporting event (e.g., the camera system 300 is a trolley camera, a handheld video camera, or an aerial video camera, such as a computer-controlled, cable-suspended video system), the signal, when executed by the processor of the display device 400, causes the display device 400 to display a graphical indication (e.g., a pin) of the athlete's position on the sports field (e.g., the football field, the soccer field, or the baseball diamond) on or adjacent to the video of user captured by the camera system 300 and/or the video captured by the wearable camera device 200.

In one or more embodiments in which the system 100 includes two or more wearable camera devices 200, the system 100 may be configured to enable a user to select which one or the two or more video feeds captured by the wearable camera devices 200 to display on the display device 400. In one or more embodiments, the system 100 may be configured to simultaneously display the video feeds captured by the two or more wearable camera 200 on the display device 400. Additionally, in one or more embodiments, system 100 may be configured to synchronously or asynchronously display the video feeds captured by the camera system 300 and the video captured by the wearable camera device 200 on the display device 400 (e.g., the video feeds captured by the camera system 300 and the video captured by the wearable camera device 200 may both be real-time, live video of the event, or one of video feeds may be a real-time, live video feed of the event and the other video may be a time-delayed video feed of the event, such as a replay of a sporting event play). Furthermore, in one or more embodiments, the system 100 may be configured to simultaneously or sequentially display the video feeds captured by the camera system 300 and the wearable camera device 200 on the display device 400 (e.g., the video feed captured by the camera system 300 may be displayed first on the display device 400 and then the video feed captured by the wearable camera device 200 may be subsequently displayed on the display device 400, or the video feeds captured by the camera system 300 and the wearable camera device 200 may be displayed simultaneously adjacent to each other, such as with one video being inset with respect to the other video feed (i.e., picture-in-picture). Additionally, in one or more embodiments in which the system 100 includes two or more wearable camera devices 200, the system 100 may be configured to integrate or merge the video feeds captured by the two or more wearable camera devices 200 into a 360-degree video. In one or more embodiments, the system 100 may be configured to integrate or merge the video feed(s) captured by the one or more wearable camera devices 200 and the video captured by the camera system 300 into a 360-degree video.

In one or more embodiments, the system 100 is configured to display a graphical user interface (GUI) (e.g., an options menu) that enables a user select which video feed to display on the display device 400 and/or to manipulate the video displayed on the display device 400. For instance, when two or more individuals are wearing a wearable camera device 200, the user may select which individual's camera feed to view. In one or more embodiments, the GUI may enable a user to manipulate the video (e.g., rotating the video clockwise or counterclockwise, panning left or right, zooming in or out, and/or by pitching up or down to view the desired portion or all of the video with the desired orientation) captured by the one or more wearable camera devices 200 and displayed on the display device 400, such as by inputting commands into a smart tv, a VR headset, or other display devices.

In one or more embodiments, the executable instructions contained in the signal transmitted by the server 500, when executed by the processor of the display device 400, cause the display device 400 to display an avatar or other graphical representation (e.g., a still image or an animation) of an athlete associated with the data captured by the wearable camera device 200 worn by the athlete. For instance, in one or more embodiments, the executable instructions contained in the signal transmitted by the server 500, when executed by the processor of the display device 400, cause the display device 400 to display an avatar or other graphical representation of the athlete and to move the aviator or other graphical representation of the athlete around the display of the display device 400 based on the positional data captured by the wearable camera device 200. Additionally, in one or more embodiments, the executable instructions contained in the signal transmitted by the server 500, when executed by the processor of the display device 400, cause the display device 400 to display the avatar or other digital representation of the athlete on a digital representation of a sporting field or court (e.g., a football field, soccer field, or a basketball court). In this manner, a play (or a portion thereof) of a sporting event may be digitally recreated. Digitally recreating a sporting event or play (or a portion thereof) in this manner enables, for instance, viewers to understand the movements of an athlete who might be obstructed from view of the camera system 300 by other players, which enables analysis of the athlete's movements not available by conventional means.

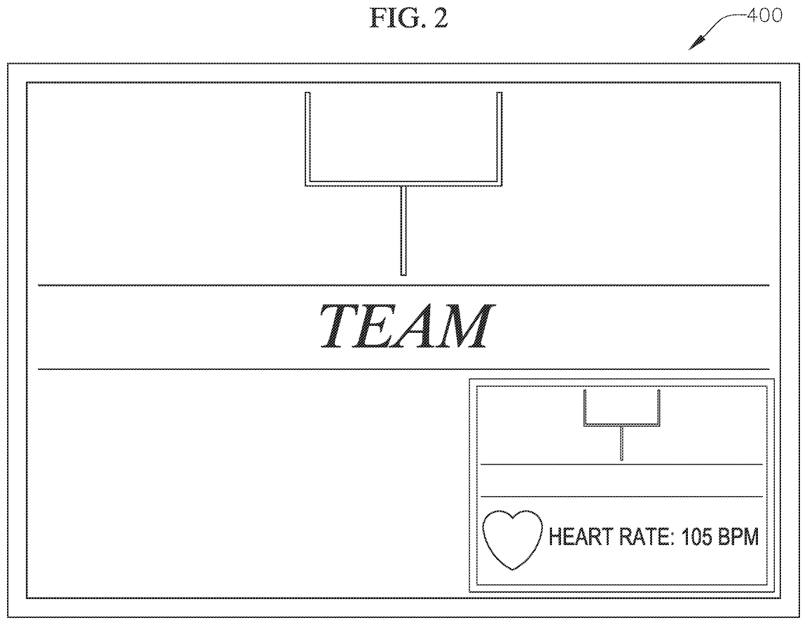

FIG. 2 is a schematic view of the integrated media displayed on the display of the display device according to one embodiment of the present disclosure. In the illustrated embodiment, the display of the display device 400 includes a third-person video (e.g., a 360-degree first-person video) of a sporting event or competition (captured by the camera system) and a first-person video of an athlete playing the sporting event or competing in the competition (captured by the wearable camera device). In the illustrated embodiment, the third-person video is displayed in a main portion of the display of the display device 400, and the first-person video is displayed in a smaller inset portion of the display of the display device 400, although in one or more embodiments the first- and third-person videos may be displayed on the display of the display device 400 in any other suitable configuration (e.g., side-by-side). In one or more embodiments, the third-person video (captured by the camera system) and the first-person video (captured by the wearable camera device) may be integrated and displayed together on the display of the display device 400. Additionally, in the illustrated embodiment, the display of the display device displays other information, such as biometric information of the athlete playing the sporting event or competing in the competition.

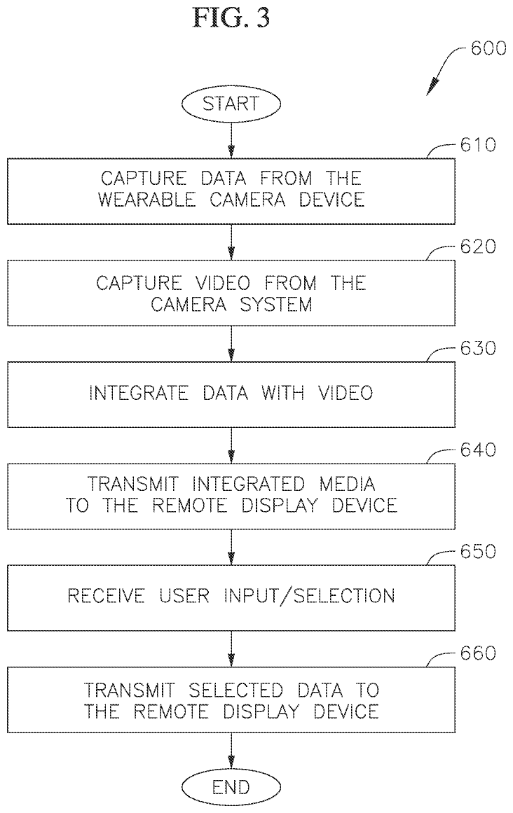

FIG. 3 is a flowchart illustrating tasks of a method 600 of capturing, transmitting, and displaying integrated media on a display device. In the illustrated embodiment, the method 600 includes a task 610 of capturing data from a wearable electronic device. The data may include video images (e.g., real-time video, such as a 360-degree real-time video), biometric data (e.g., heart rate), and/or positional data. Additionally, in one or more embodiments, the data captured in task 610 may be captured while the wearable electronic device is worn by an athlete during the performance of an athletic event (e.g., a football game or a baseball game). In one or more embodiments, the task 610 includes capturing first-person video from the perspective of the athlete performing the athletic event. The wearable camera system may be, for example, incorporated into a helmet, a baseball cap, or a headband worn by an athlete during the task 610 of capturing the data from the wearable electronic device.

In the illustrated embodiment, the method 600 also includes a task 620 of capturing video by a camera system. The camera system may be a sideline video camera, such as a trolley camera, a handheld video camera, or an aerial video camera, such as a computer-controlled, cable-suspended video system. In one or more embodiments, the task 620 of capturing video includes capturing video of the individual user wearing the wearable electronic device (utilized in task 610 to capture data). For instance, in one or more embodiments in which the wearable camera device is worn by an athlete during performance of an athletic event, the video captured in task 620 may be a video of the athletic event and the athlete performing the athletic event (e.g., the video of the athletic event may be captured by a sideline video camera, such as a trolley camera, a handheld video camera, or an aerial video camera, such as a computer-controlled, cable-suspended video system). That is, in one or more embodiments, the task 620 includes capturing third-person video of the athlete performing the athletic event.

Additionally, in the illustrated embodiment, the method 600 includes a task 630 of integrating the data captured by the wearable camera device (in task 610) with the video captured by the camera system (in task 620) to form integrated media. In one or more embodiments, the data captured by the wearable electronic device in task 610 and the video captured by the camera system in task 620 may be transmitted to a server, and then the server may integrate the data captured by the wearable electronic device with the video captured by the camera system to form the integrated media. In one or more embodiments, the task 630 of integrating the data with the video may include overlaying video captured by the wearable electronic device on the video captured by the video camera. In one or more embodiment, the task 630 of integrating the data with the video may include positioning the video captured by the wearable electronic device in close proximity to (e.g., adjacent to, overlaid on, or inset in) the video captured by the video camera. In one or more embodiments, the task 630 of integrating the data with the video may include displaying biometric data (e.g., heart rate) or location data (e.g., position on the sport field or court) either alone or in combination with the video captured by the wearable electronic device. In one or more embodiments, the task 630 may include integrating the videos feeds captured by two or more wearable camera devices into a 360-degree video. In one or more embodiments, the task 630 may include integrating the videos feed(s) captured by one or more wearable camera devices and the video feed captured by the camera system into a 360-degree video.

In the illustrated embodiment, the method 600 also includes a task 640 of transmitting the integrated media to the display of a remote display device (e.g., a television (such as a “smart” television) or a computer, such as a laptop, a desktop computer, a tablet computer, a smart phone, or a wearable electronic device, such as a smart watch or a augmented reality (AR) or virtual reality (VR) headset). In response to receiving the integrated media, the display of the display device displays the data captured by the wearable camera device and the video captured by the camera system. In this manner, a viewer may be able to view both a third-person and first-person perspective of the individual, such as an athlete, wearing the wearable electronic device. Additionally, a viewer may be able to view biometric data and/or positional data of an athlete in addition to the video of the game or other athletic event. Furthermore, in one or more embodiments, the integrated media may include an avatar or other graphical representation of the individual (e.g., the athlete) wearing the wearable camera device on a graphical representation of a sport field or court (e.g., a football field or a basketball court), and the position of the avatar or other graphical representation of the individual on the graphical representation of the sport field or court may correspond to the positional data of the individual captured by the wearable camera device. In one or more embodiments, the task 640 includes displaying a 360-degree video stream (e.g., a 360-degree video captured by one wearable camera device, a 360-degree video generated by integrating or merging two or more video streams captured by two or more wearable camera devices, and/or a 360-degree video generated by integrating or merging one or more video streams captured by one or more wearable camera devices with the video feed captured by the camera system) on the display of the display device (e.g., a computer, a “smart” television, or AR or VR headset), and the user may “scroll” the camera view displayed on the display to view a desired portion of the 360-degree video.

In one or more embodiments in which data is captured from two or more wearable electronic devices in task 610, the method 600 may include a task 650 of receiving an input or selection from a user (e.g., an input made in a graphical user interface, such as a menu, displayed on the display of the display device), and a task 660 of transmitting, to the display device, the data captured by the one or more wearable electronic devices selected by the user. For instance, a user may select to view the first-person video and/or the biometric data of a particular athlete during the performance of the sporting event.

While this invention has been described in detail with particular references to embodiments thereof, the embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without meaningfully departing from the principles, spirit, and scope of this invention.

What is claimed is:

1. A method of transmitting integrated media to a display device, the method comprising:
integrating data captured by a wearable camera device with video captured by a camera system to form the integrated media; and
transmitting the integrated media to a display device remote from the wearable camera device and the camera system.

2. The method of claim 1, wherein the data captured by the wearable camera device comprises a first-person video from an individual in a scene, and wherein the video captured by the camera system comprises third-person video of the individual in the scene.

3. The method of claim 2, wherein the first-person video and the third-person video are played simultaneously in the integrated media.

4. The method of claim 2, wherein the first-person video and the third person video are played sequentially in the integrated media.

5. The method of claim 1, wherein the integrated media comprises a 360-degree video.

6. The method of claim 1, wherein the wearable camera device is worn by an athlete during performance of an athletic event.

7. The method of claim 1, wherein the data is selected from the group consisting of a video, biometric data, location data, and combinations thereof.

8. The method of claim 1, wherein the wearable electronic device comprises a helmet, a baseball cap, or a sweatband.

9. The method of claim 1, wherein the data comprises positional data of an athlete on a sporting field wearing the wearable camera device, wherein the integrated media further comprises an avatar of the athlete on a graphic representation of the sporting field, and wherein a position of the avatar corresponds to the positional data.

10. A method of displaying integrated media on a display device, the method comprising:
receiving, by the display device, integrated media comprising data captured by at least one wearable camera device and video captured by a camera system; and
displaying, on a display of the display device, the integrated media.

11. The method of claim 10, wherein the data captured by the at least one wearable camera device comprises a first video feed captured by a first wearable camera device and a second video feed captured by a second wearable camera device.

12. The method of claim 11, further comprising:
displaying, on the display of the display device, a menu; and
displaying, on the display of the display device, the first video feed or the second video feed in response to a selection entered in the menu.

13. The method of claim 10, wherein the data captured by the wearable camera device comprise a first-person video from an individual in a scene, and wherein the video captured by the camera system comprises third-person video of the individual in the scene.

14. The method of claim 13, wherein the displaying the integrated media comprises simultaneously playing the first-person video and the third-person video on the display of the display device.

15. The method of claim 13, wherein the displaying the integrated media comprises sequentially playing the first-person video and the third-person video on the display of the display device.

16. The method of claim 10, wherein the wearable camera device is worn by an athlete during performance of an athletic event.

17. The method of claim 10, wherein the data is selected from the group consisting of a video, biometric data, location data, and combinations thereof.

18. The method of claim 10, wherein the wearable camera device comprises a helmet, a baseball cap, or a sweatband.

19. The method of claim 10, wherein the data comprises positional data of an athlete on a sporting field wearing the wearable camera device, and wherein the displaying the integrated media further comprises displaying an avatar of the athlete on a graphic representation of the sporting field, a position of the avatar corresponding to the positional data.

20. The method of claim 10, wherein the integrated media comprises a 360-degree video.
